(19) United States
(12) Patent Application Publication
(10) Pub. No.: US 2007/0233447 A1
(43) Pub. Date: Oct. 4, 2007

(54) Circuit simulation method and circuit simulation apparatus

(75) Inventors: Ryo Miyata, Kanagawa (JP); Hironori Sakamoto, Kanagawa (JP)

Correspondence Address: FOLEY AND LARDNER LLP;SUITE 500, 3000 K STREET NW, WASHINGTON, DC, 20007, US

(73) Assignee: NEC ELECTRONICS CORPORATION

(21) Appl. No.: 11/730,012

(22) Filed: Mar. 29, 2007

(30) Foreign Application Priority Data
Mar. 30, 2006 (JP) 2006-095106

(51) Int. Cl. G06F 17/50

(52) U.S. Cl. 703/14; 716/4

(57) ABSTRACT

A circuit simulation method for estimating electrical characteristics of a semiconductor device is provided. The circuit simulation method includes: (A) generating a device model parameter of a semiconductor device model used in a circuit simulation; and (B) executing the circuit simulation by using the semiconductor device model and the generated device model parameter. The (A) step includes: (a) generating a plurality of device model parameters with respect to a plurality of different temperatures; and (b) generating the device model parameter corresponding to a specified temperature by interpolating between the plurality of device model parameters.

### BACKGROUND OF THE INVENTION

1. Field of the Invention

The present invention relates to a circuit simulation method and a circuit simulation apparatus. In particular, the present invention relates to a technique for generating a device model parameter applied to a circuit simulation.

b 2. Description of the Related Art

As a semiconductor technology advances, an LSI (Large Scale Integrated Circuit) having a more complicated configuration has been developed. In order to develop the LSI having a complicated configuration, a long development period and a heavy investment are required. The increase in the development cost and development period required for the development of the LSI prevents price-reduction of the LSI. In order to achieve the price-reduction of the LSI, it is required to reduce the development cost and to shorten the development period.

A simulation technique is known as one of methods for reducing the development cost and shortening the development period. For example, a circuit simulation is carried out by using CAD at an initial stage of processes of developing a semiconductor device. In the circuit simulation, a “semiconductor device model” which is a numerical expression of electrical characteristics of a semiconductor device is used. A “device model parameter” which is a parameter relating to the characteristics of the semiconductor device is given to the semiconductor device model, and thereby the electrical characteristics of an actual semiconductor device are estimated.

In general, a semiconductor device is provided with a large number of transistors. The electrical characteristics of the transistor constituting the semiconductor device are expressed by a transistor model. The transistor model describes the electrical characteristics of an actual transistor in an approximate expression (equation). In order to estimate the electrical characteristics of the actual semiconductor device by the circuit simulation with a high degree of accuracy, it is highly required that the transistor model describes the actual transistor with a high degree of accuracy.

In particular, a transistor constituting a state-of-the-art semiconductor device has various complicated physical effects and parasitic effects. As a transistor model describing such a transistor, the “BSIM (Berkeley Short-Channel IGFET Model)” is known. The BSIM is a transistor model specific to the circuit simulation and is capable of precisely describing various effects such as a short channel effect, a narrow channel effect, a substrate bias effect and so on. Therefore, the BSIM has a high reputation for high physical aspect and is used in many cases as a present de-facto standard.

A circuit simulator executes the circuit simulation by using the BSIM and the device model parameters. It is necessary prior to the circuit simulation to generate and adjust the large number of device model parameters such that an error between I-V (current-voltage) characteristics of the actual transistor and I-V characteristics calculated by the circuit simulator becomes as small as possible. Such an operation with respect to the device model parameters is called “parameter extraction”.

The BSIM has a complicated computation expression including a large number of device model parameters. It is necessary that the parameter extraction is carried out appropriately such that the device model parameters of the BSIM fit in with physical phenomena of the transistor. Japanese Laid-Open Patent Application JP-P2000-322456A discloses a technique for extracting the device model parameters with respect to the BSIM.

FIG. 1 schematically shows a process flow of the BSIM parameter extraction described in the above-mentioned patent document. In the conventional BSIM parameter extraction, a device characteristics measurement data 101 is generated by measuring the electrical characteristics of an actual transistor. The device characteristics measurement data 101 indicates a gate voltage dependence of a drain current (Ids−Vgs characteristics) and a drain voltage dependence of the drain current (Ids−Vds characteristics). An intermediate data generating function 102 generates an intermediate data 103 on the basis of the device characteristics measurement data 101 and records the generated intermediate data 103 on an external storage device. The intermediate data 103 indicates the electrical characteristics of the transistor such as the short channel effect (Lg−Vth), the narrow channel effect (W−Vth), the substrate effect and the like, which are obtained from the device characteristics measurement data 101. Based on the intermediate data 103 and a device structure data 104, a parameter extracting function 105 extracts each of the device model parameters of the BSIM and thereby generates a model parameter set (BSIM parameter set) 106.

According to the technique disclosed in the above-mentioned patent document, the BSIM parameters are hierarchically classified and the parameter extraction is carried out in accordance with the classification. More specifically, the BSIM parameters are first classified into four groups consisting of physical phenomenon parameters, process parameters, constant parameters and fitting parameters. Furthermore, the physical phenomenon parameters are classified into model parameters relating to a threshold voltage and model parameters relating to a current value. Moreover, the process parameters are classified into model parameters relating to a structure and model parameters relating to impurity profile (impurity implantation amount). Also, the constant parameters are classified into model parameters relating to mobility and model parameters relating to saturated velocity. The fitting parameters are classified as the other model parameters.

FIG. 2 is a flowchart showing the parameter extraction according to the conventional technique described in the above-mentioned patent document. Here, the Ids−Vds characteristics and the Ids−Vgs characteristics of a plurality of devices are measured, and the measured characteristics are provided as measurement data. The physical phenomena of the device are analyzed by using the measurement data, and the device model parameters are extracted based on the result of the analysis. With reference to FIG. 2, phenomena relating to the threshold voltage are first analyzed based on the measurement data and thereby the device model parameters with regard to the threshold voltage is extracted (Step F101). Secondly, the device model parameters with regard to the current in the physical phenomenon parameters are extracted (Step F102). Thirdly, the device model parameters with regard to the structure in the process parameters are extracted (Step F103) Fourthly, the device model parameters with regard to the impurity profile are extracted (Step F104) After that, the device model parameters with regard to the mobility and the saturated velocity are extracted (Steps F105 and F106). Finally, the fitting parameters are extracted (Step F107).

According to the conventional parameter extraction, as described above, the BSIM parameters are hierarchically classified and also the intermediate data are generated by processing the measurement data of the Ids−Vds characteristics and the Ids−Vgs characteristics. By using the intermediate data, the device model parameters with regard to respective physical phenomena are extracted.

Some of the physical phenomena to be estimated by the circuit simulation have “temperature dependence”. In order to support the temperature dependence, the BSIM is provided with about 20 kinds of model parameters relating to the temperature. More specifically, the temperature dependence of DC characteristics in the BSIM is incorporated into the model expressions of the threshold voltage, the mobility, the saturated velocity and the like, and the parameter extraction is carried out based on the model expressions.

For example, the model expression of the threshold voltage having the temperature dependence is as follows.

Vth(T)=Vth(TNOM)+(KT1+KT1L/Leff+KT2*Vbseff)*(T/TNOM−1)

The model expressions of the mobility having the temperature dependence are as follows.

UO(T)=UO(TNOM)*(T/TNOM)^{UTE}

UA(T)=UA(TNOM)+UA1*(T/TNOM−1)

UB(T)=UB(TNOM)+UB1*(T/TNOM−1)

UC(T)=UC(TNOM)+UC1*(T/TNOM−1)

The model expression of the saturated velocity having the temperature dependence is as follows.

VSAT(T)=VSAT(TNOM)−AT*(T/TNOM−1)

### SUMMARY OF THE INVENTION

With increasing miniaturization of semiconductor manufacturing processes, it is required to estimate the electrical characteristics of the transistor by using a transistor model with a higher degree of accuracy. In particular, an OFF-current, which is a current flowing when operating potential is not applied to a gate electrode of a transistor, is increasing as the device is miniaturized. Therefore, it is important in the circuit simulation to estimate the OFF-current at a high degree of accuracy.

One kind of the OFF-current is a GIDL (Gate-Induced Drain Leakage) current. The GIDL current is a current which flows from a drain to a substrate when the transistor is in OFF-state, due to a strong electric field applied to an edge of the drain under the gate electrode.

FIG. 3 is a graph of Ids−Vgs (drain current−gate voltage) characteristics of an actual transistor. Shown in FIG. 3 are several Ids−Vgs characteristics for different temperatures. In the graph, a section indicated by a region “A” represents the GIDL current. As shown in FIG. 3, the amount of the GIDL current changes depending on the temperature of the device. That is to say, the GIDL current has the temperature dependence.

The BSIM estimates the GIDL current by using a model parameter relating to the GIDL current. However, the BSIM does not support the temperature dependence of the GIDL current. Therefore, the extraction of the model parameter relating to the GIDL current is carried out based on the measurement data under a room temperature.

FIG. 4 shows a result of a circuit simulation using the BSIM (indicated by dashed lines) in addition to the measurement data shown in FIG. 3. As can be seen from a comparison between the result of the circuit simulation and the measurement data, the precision of the simulation result is lower within the above-mentioned region “A” than that outside the region “A”. The GIDL current estimated by the circuit simulation using the conventional BSIM deviates from the measurement data particularly at a high temperature. This results from the fact that the temperature dependence is not incorporated into the model expression of the GIDL current in the conventional BSIM.

In order to estimate the GIDL current with a high degree of accuracy, the parameter extraction is required to be carried out such that the simulation result fits in with the measurement data within the above-mentioned region “A”. However, as described above, the BSIM does not support the temperature dependence of the GIDL current. Therefore, it is difficult to carry out the parameter extraction such that the simulation result and the measurement data match with each other.

An object of the present invention is to provide a technique which can estimate the electrical characteristics of a semiconductor device with a higher degree of accuracy.

In a first aspect of the present invention, a circuit simulation method for estimating electrical characteristics of a semiconductor device is provided. The circuit simulation method includes: (A) generating a device model parameter of a semiconductor device model used in a circuit simulation; and (B) executing the circuit simulation by using the semiconductor device model and the generated device model parameter. The (A) step includes: (a) generating a plurality of device model parameters with respect to a plurality of different temperatures; and (b) generating the device model parameter corresponding to a specified temperature by interpolating between the plurality of device model parameters.

In a second aspect of the present invention, a computer program product is provided. The computer program product is embodied on a computer-readable medium and, when executed, causes a computer to perform the above-mentioned circuit simulation method.

In a third aspect of the present invention, a circuit simulation apparatus for estimating electrical characteristics of a semiconductor device is provided. The circuit simulation apparatus has: a parameter generation module configured to generate a device model parameter of a semiconductor device model; and a simulation module configured to execute a circuit simulation by using the semiconductor device model and the generated device model parameter. The parameter generation module generates a plurality of device model parameters with respect to a plurality of different temperatures, and generates the device model parameter corresponding to a specified temperature by interpolating between the plurality of device model parameters.

According to the present invention, as described above, the plurality of reference model parameters are generated with respect to the plurality of different temperatures. When an arbitrary temperature is specified, the device model parameter corresponding to the specified temperature can be generated by interpolating between the plurality of reference model parameters. In this manner, the device model parameter can be obtained with high precision, even if temperature dependence of the device model parameter is not supported by the semiconductor device model

The circuit simulation is executed by using the semiconductor device model and the generated device model parameter. Since the device model parameter is obtained in consideration of the temperature dependence, the electrical characteristics of the semiconductor device can be estimated with a higher degree of accuracy.

### BRIEF DESCRIPTION OF THE DRAWINGS

The above and other objects, advantages and features of the present invention will be more apparent from the following description taken in conjunction with the accompanying drawings, in which:

FIG. 1 is a view showing a schema of a process flow of a conventional model parameter extraction;

FIG. 2 is a flowchart showing an order of the conventional model parameter extraction;

FIG. 3 is a graph showing a device characteristics measurement data;

FIG. 4 is a graph showing a relation between the device characteristics measurement data and a result of a conventional circuit simulation;

FIG. 5 is a flowchart schematically showing a circuit simulation method according to the present invention;

FIG. 6 is a block diagram showing an example of a configuration of a circuit simulation apparatus according to the present invention;

FIG. 7 is a block diagram showing an example of a data storage unit in the circuit simulation apparatus;

FIG. 8 is a block diagram showing an example of a program storage unit in the circuit simulation apparatus;

FIG. 9 is a flowchart showing a method of generating intermediate data in the parameter extraction according to the present invention;

FIG. 10 is a flowchart showing a method of generating device model parameter sets in the parameter extraction according to the present invention;

FIG. 11 is a graph visually showing an example of the parameter extraction according to the present invention;

FIG. 12 is a flowchart showing a method of determining a device model parameter whose temperature dependence is not supported by a device model and a method of a circuit simulation at a temperature Tx;

FIG. 13 is a graph showing a relation between device characteristics measurement data and a result of the circuit simulation according to the present invention; and

FIGS. 14A and 14B are graphs showing the result of the circuit simulation according to the present invention and the conventional technique, respectively.

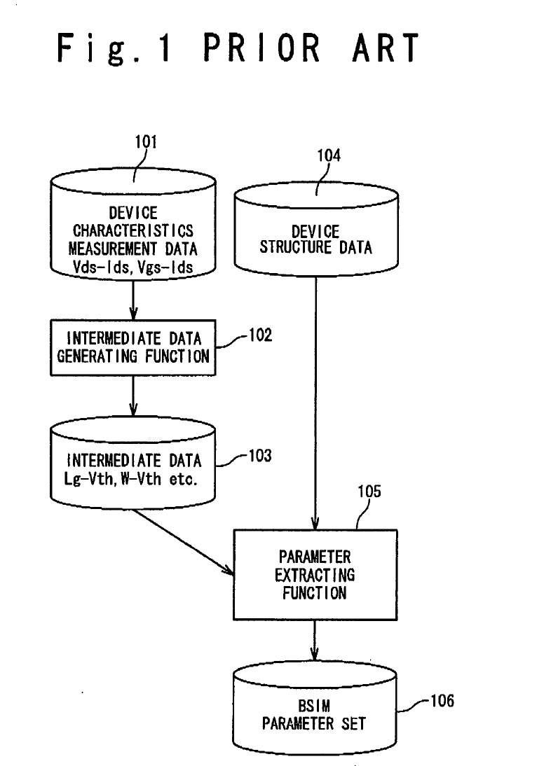

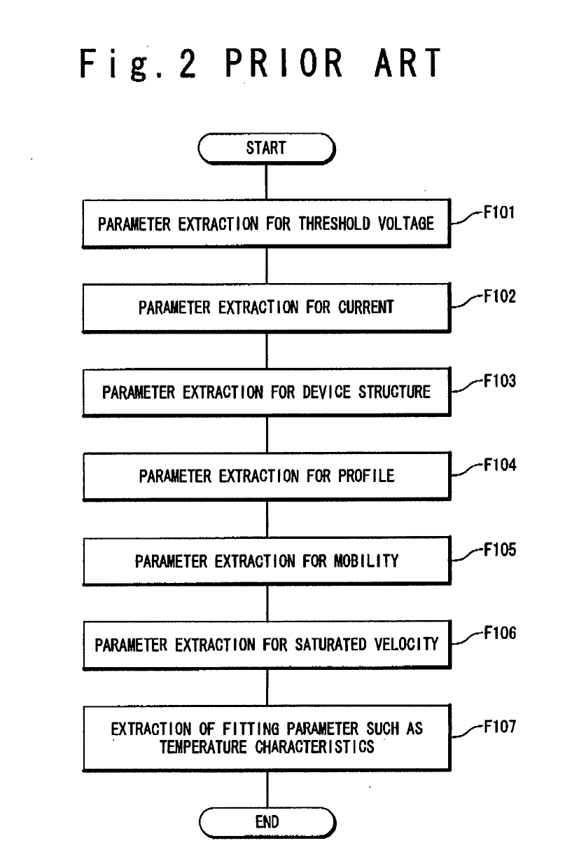

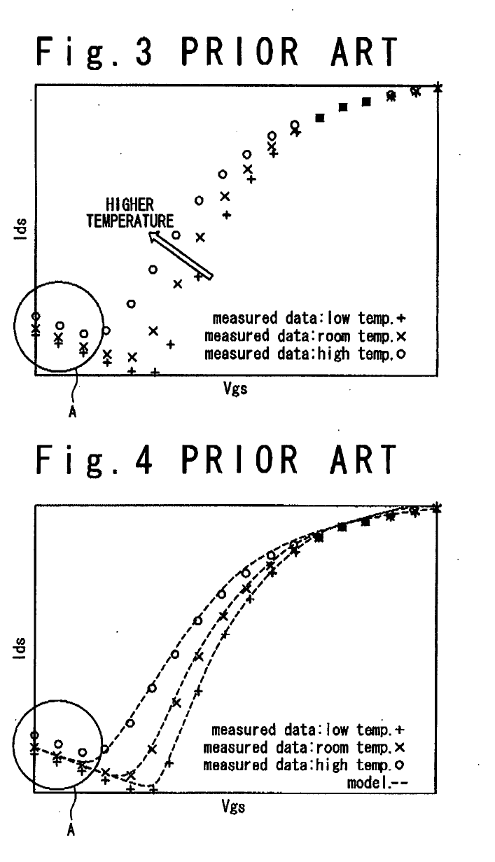

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

In the following embodiment, the BSIM4 (Berkeley Short-Channel IGFET Model Version 4) is used as an example of a transistor model (semiconductor device model). In the present embodiment, the device characteristics measurement data used in the parameter extraction is generated and provided prior to the parameter extraction. The device characteristics measurement data can be generated by measuring electrical characteristics of an actual semiconductor device by the use of a measurement-specific apparatus. The device characteristics measurement data is measured under a plurality of different temperatures, and a plurality of device characteristics measurement data are generated for the plurality of different measurement temperatures, respectively. The plurality of device characteristics measurement data are stored in a storage device. Moreover, the device structure data is also generated and provided prior to the parameter extraction. The device structure data can be generated by observing the structure of the semiconductor device by the use of an analysis equipment such as a SEM (Scanning Electron Microscope) and the like.

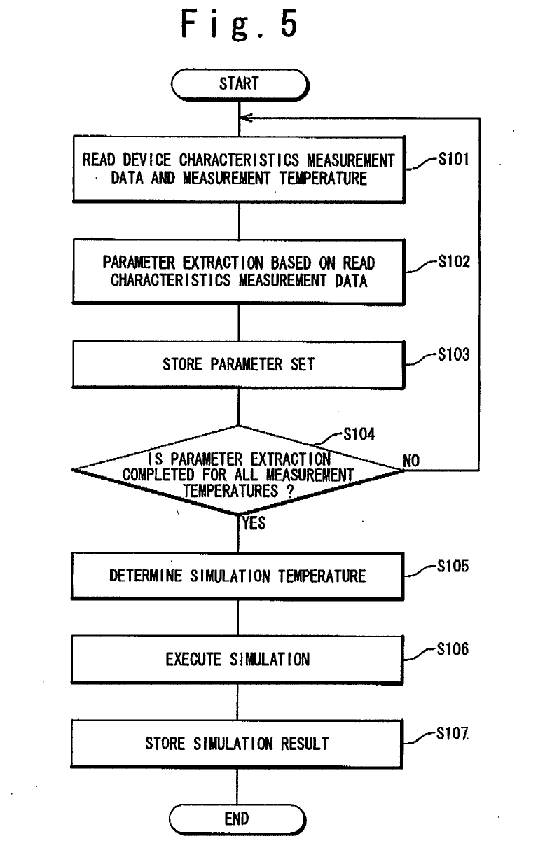

FIG. 5 is a flowchart schematically showing a circuit simulation method according to the present embodiment. According to the circuit simulation method, device model parameters are first extracted and then a circuit simulation is executed by using the extracted device model parameters in order to estimate electrical characteristics of a semiconductor device. In the circuit simulation method, a parameter generation module and a simulation module operates in cooperation with each other. The parameter generation module carries out the parameter extraction and generates the device model parameters of the transistor model used in the circuit simulation. On the other hand, the simulation module executes the circuit simulation by using the transistor model and the generated device model parameters.

With reference to FIG. 5, the parameter extraction is first performed. At a Step S101, a device characteristics measurement data and the corresponding measurement temperature are read out from the storage device. At a Step S102, the parameter extraction with respect to the measurement temperature is carried out based on the read device characteristics measurement data and thus the device model parameters are extracted. It should be noted that the device model parameters include a device model parameter whose temperature dependence is not supported by the transistor model. At a Step S103, a parameter set with respect to the measurement temperature is generated based on the extracted device model parameters, and the generated parameter set is stored in the storage device.

At a Step S104, it is judged whether or not the parameter extraction is completed for all the measurement temperatures. If there remains a measurement temperature for which the parameter extraction is not executed yet, the process returns back to the Step S101 and another device characteristics measurement data is read out. If the parameter extraction is completed for all the measurement temperatures, the process proceeds to a Step S105. In this manner, the parameter extraction according to the present embodiment is executed with respect to each of the plurality of device characteristics measurement data whose measurement temperatures are different from each other. It should be noted that in the conventional parameter extraction, the device model parameter whose temperature dependence is not supported by the BSIM is extracted by using a device characteristics measurement data of a room temperature.

At a Step S105, a temperature condition (simulation temperature) in the circuit simulation is specified. At a Step S106, the simulation module executes the circuit simulation under the specified temperature condition. According to the present embodiment, the device model parameter whose temperature dependence is not supported by the transistor model is modified prior to the circuit simulation. As described later, such the modification of the device model parameter is carried out on the basis of the parameter sets generated in the Steps S101 to S104. After the modification procedure, the circuit simulation is executed. At a Step S107, a result of the circuit simulation is stored in the storage device.

According to the present embodiment, as described above, the parameter extraction is carried out with respect to every device characteristics measurement data whose measurement temperatures are different from each other, even if the temperature dependence of the target device model parameter is not supported. Then, the device model parameter is modified through a procedure to be described later so that precision of the circuit simulation is improved. Detailed configuration and procedure of the present embodiment will be described below.

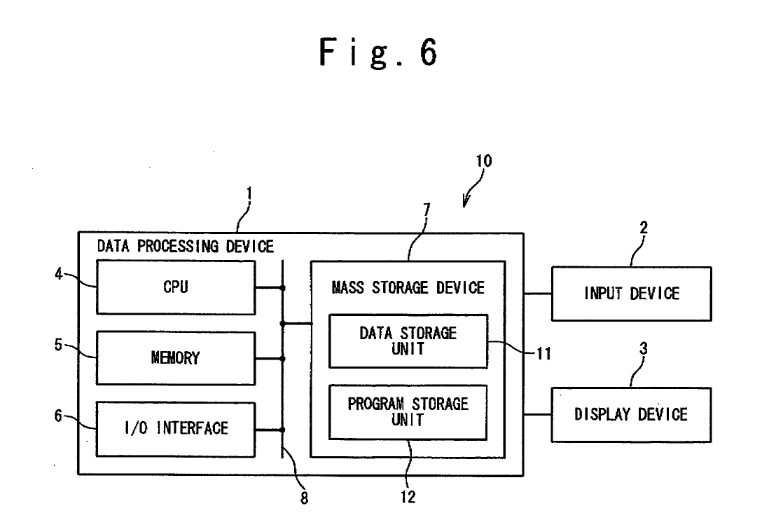

FIG. 6 is a block diagram showing an example of a configuration of a circuit simulation apparatus 10 according to the present embodiment, As shown in FIG. 6, the circuit simulation apparatus 10 according to the present embodiment is provided with a data processing device 1, an input device 2 and a display device 3.

The data processing device 1 is a high-speed processor such as a personal computer, a work station or the like. The input device 2 is a man-machine interface providing a function of inputting data to the data processing device 1. The input device 2 is exemplified by a keyboard, a mouse and the like. In the present embodiment, the input device 2 is a keyboard. The display device 3 is a man-machine interface providing a function of outputting a result of the processing by the data processing device 1 to the outside. The display device 3 is exemplified by a CRT display, a liquid crystal display and the like. In the present embodiment, the display device 3 visually displays the extracted device model parameters, the result of the circuit simulation and so forth.

As shown in FIG. 6, the above-mentioned data processing device 1 is provided with a CPU (Central Processing Unit) 4, a memory 5, an input/output interface 6 and a mass storage device 7 which are connected to each other through a bus 8. The CPU 4 controls the various devices installed in the circuit simulation apparatus 10 and processes data input to and output from the data processing device 1. The CPU 4 analyzes and processes the data received from the input device 2 and outputs the result of the processing to the display device 3. The memory 5 is a storage unit to which data is written and from which data is read. The memory 5 is exemplified by an SDRAM, a DDR-SDRAM or the like. The input/output interface 6 is a device for controlling a data communication between the data processing device 1 and the input device 2 or the display device 3. The mass storage device 7 is a device used for storing the large amount of data. The mass storage device 7 is exemplified by an HDD (Hard Disc Drive) or the like. As shown in FIG. 6, the mass storage device 7 includes a data storage unit 11 and a program storage unit 12.

The data storage unit 11 of the mass storage device 7 is a memory region for storing the data used in and generated by the data processing according to the present embodiment. The program storage unit 12 of the mass storage device 7 is a memory region for storing computer programs that achieves the data processing according to the present embodiment. The data storage unit 11 and the program storage unit 12 will be described below in detail with reference to the drawings.

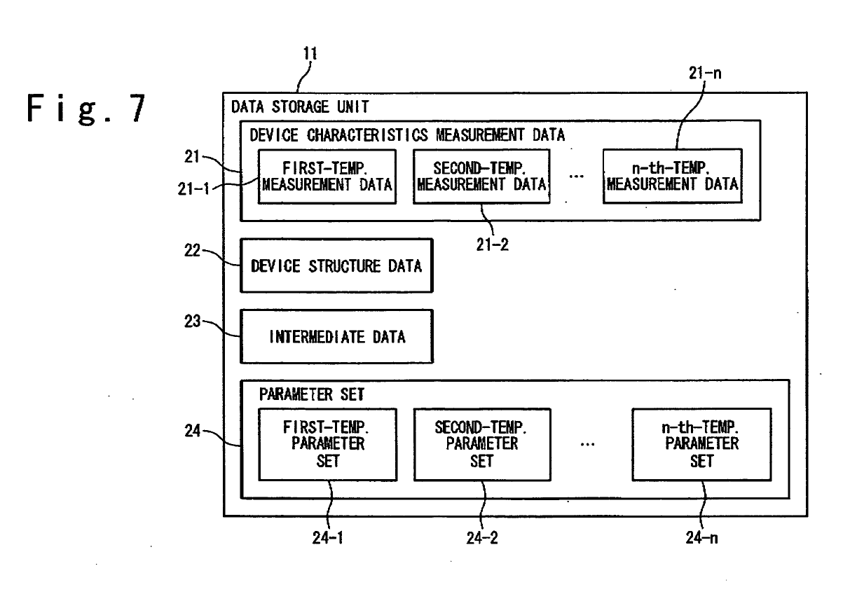

FIG. 7 is a block diagram showing the data storage unit 11 according to the present embodiment. Stored in the data storage unit 11 are device characteristics measurement data 21, device structure data 22, intermediate data 23, parameter sets 24 and so on.

The device characteristics measurement data 21 consists of a plurality of device characteristics measurement data 21-1 to 21-n. Each of the device characteristics measurement data 21-1 to 21-n indicates electrical characteristics of an actual transistor such as a gate voltage dependence of a drain current (Ids−Vgs characteristics) and a drain voltage dependence of the drain current (Ids−Vds characteristics). The plurality of device characteristics measurement data 21-1 to 21-n are measured under a plurality of different measurement temperatures, respectively. For example, the device characteristics measurement data 21-1 is measured under a first temperature and may be referred to as a first-temperature measurement data 21-1. Similarly, the device characteristics measurement data 21-n is measured under an n-th temperature and may be referred to as an n-th-temperature measurement data 21-n. The device structure data 22 indicates a structure of the semiconductor device that is a target of the circuit simulation. The intermediate data 23 indicates the electrical characteristics of the transistor such as the short channel effect, the narrow channel effect, the substrate effect and the like, which are obtained from the device characteristics measurement data 21. The parameter sets 24 consists of a plurality of parameter sets 24-1 to 24-n (a first-temperature parameter set 24-1 to an n-th-temperature parameter set 24-n). Each of the parameter sets 24-1 to 24-n includes the device model parameters obtained by the parameter extraction to be described later. The plurality of parameter sets 24-1 to 24-n correspond to the plurality of different measurement temperatures, respectively.

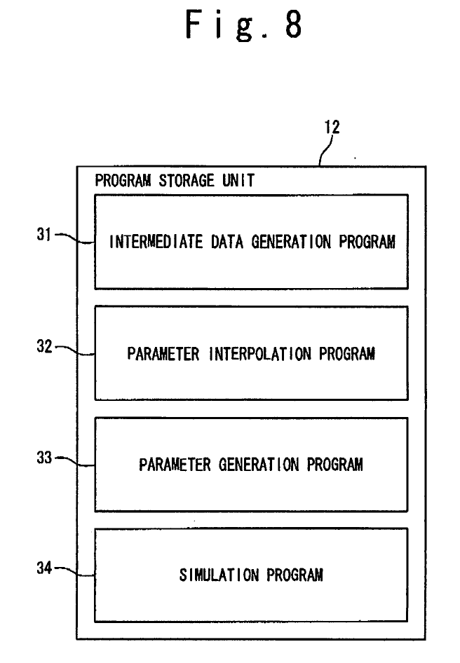

FIG. 8 is a block. diagram showing the program storage unit 12 according to the present embodiment. Stored in the program storage unit 12 are an intermediate data generation program 31, a parameter interpolation program 32, a parameter generation program 33 and a simulation program 34. The intermediate data generation program 31, the parameter interpolation program 32, the parameter generation program 33 and the simulation program 34 are computer programs executed by the data processing device 1 and constitute a circuit simulation program achieving the processing shown in FIG. 5. The intermediate data generation program 31 provides a function of generating the above-mentioned intermediate data 23. The parameter interpolation program 32 provides a function of determining a device model parameter whose temperature dependence is not supported by the transistor model. The parameter generation program 33 provides a function of executing the parameter extraction with respect to the plurality of different measurement temperatures based on the device characteristics measurement data 21. The simulation program 34 provides a function of executing the circuit simulation based on the transistor model (semiconductor device model) and the corresponding device model parameters. The above-mentioned programs may be recorded on a computer-readable medium.

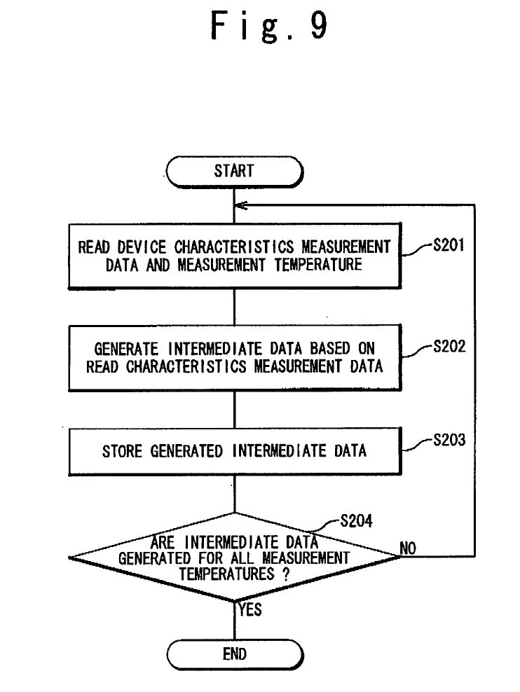

Next, an operation of the circuit simulation apparatus 10 according to the present embodiment will be described below. FIG. 9 is a flowchart showing a method of generating the intermediate data 23 in the parameter extraction according to the present embodiment. The parameter extraction starts in response to a parameter generation command input by using the input device 2. The CPU 4 of the data processing device 1 reads the intermediate data generation program 31 and the parameter generation program 33 from the program storage unit 12 and executes the procedures in accordance with the read programs.

At a Step S201, the data processing device 1 reads one device characteristics measurement data 21 and the corresponding measurement temperature information from the data storage unit 11 in accordance with the intermediate data generation program 31. The measurement temperature information indicates the measurement temperature at which the device characteristics measurement data 21 is measured.

At a Step S202, the data processing device 1 generates the intermediate data 23 by using the read device characteristics measurement data 21 in accordance with the intermediate data generation program 31, More specifically, the data processing device 1 generates the intermediate data 23 indicative of the device characteristics such as the short channel effect, the narrow channel effect, the substrate effect, a sub-threshold swing characteristic, a surface punch through characteristic and so forth, based on the device characteristics measurement data 21 indicative of the Vds−Ids characteristics and the Vgs−Ids characteristics. At a Step 5203, the generated intermediate data 23 is stored in the data storage unit 11.

At a Step S204, it is judged whether or not the intermediate data 23 are generated for all the stored device characteristics measurement data 21. As described above, the device characteristics measurement data 21 consists of the first-temperature measurement data 21-1 to the n-th-temperature measurement data 21-n with respect to the different measurement temperatures. It is judged whether or not the intermediate data 23 are generated for all the measurement temperatures. If there remains a device characteristics measurement data 21 for which the corresponding intermediate data 23 is not generated yet, the process returns back to the Step S201, and another device characteristics measurement data 21 and the corresponding measurement temperature are read out. If the intermediate data 23 are generated for all the stored device characteristics measurement data 21, the process of generating the intermediate data 23 is finished. In this manner, the intermediate data 23 are generated with respect to the plurality of different measurement temperatures according to the parameter extraction of the present embodiment.

Next, the device model parameters are extracted based on the intermediate data 23 thus generated and the device structure data 22. According to the present embodiment, a set of the device model parameters is extracted for every measurement temperatures. A set of the device model parameters associated with a measurement temperature is referred to as a “parameter set”. In the present embodiment, the plurality of parameter sets 24-1 to 24-n shown in FIG. 7 are generated with respect to the plurality of different measurement temperatures, respectively. In the parameter extraction, the plurality of parameter sets 24-1 to 24-n are so generated as to fit in with the plurality of device characteristics measurement data 21-1 to 21-n. The operation for generating the parameter set 24 for each measurement temperature will be explained below.

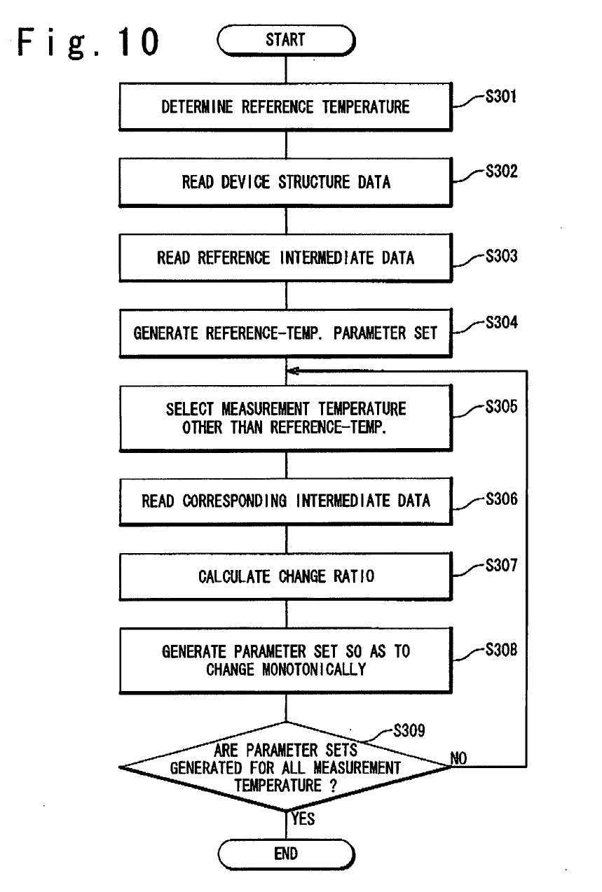

FIG. 10 is a flowchart showing a method of generating the parameter sets 24 in the parameter extraction according to the present embodiment. At a step S301, a reference-temperature is determined in order to generate parameter sets to be used as a reference. Here, two adjacent temperatures are specified as the reference-temperature out of the plurality of measurement temperatures. At a Step S302, the device structure data 22 that is prepared and stored in advance is read out from the data storage unit 11. At a Step S303, the above-mentioned intermediate data 23 associated with the specified reference-temperature are read out from the data storage unit 11. The read intermediate data 23 associated with the reference-temperature are referred to as “reference intermediate data”.

At a Step S304, parameter sets associated with the reference-temperature are generated through the parameter extraction based on the above-mentioned reference intermediate data and the device structure data 22. The generated parameter sets associated with the reference-temperature are referred to as “reference-temperature parameter sets”. As described above, the reference-temperature includes the two measurement temperatures, a first reference-temperature and a second reference-temperature. Therefore, when the reference-temperature parameter sets are generated, a first reference-temperature parameter set associated with the first reference-temperature and a second reference-temperature parameter set associated with the second reference-temperature are generated. Here, it is preferable that the first reference-temperature corresponds to a temperature of the use environment of the semiconductor device. For example, in a case where the use environment is at a room temperature, the first reference-temperature is set to the room temperature (20 to 25 degrees centigrade).

Next, the parameter extraction is performed for the measurement temperatures other than the reference-temperature. At a Step S305, a measurement temperature other than the reference-temperature is selected from the plurality of measurement temperatures. At a Step S306, the intermediate data 23 corresponding to the selected measurement temperature is read out from the data storage unit 11. At a Step S307, a change ratio of the reference-temperature parameter sets is calculated based on a difference between the first reference-temperature parameter set and the second reference-temperature parameter set and a difference between the first reference-temperature and the second reference-temperature. It is found that the reference-temperature parameter sets tend to increase or decrease in accordance with the measurement temperature.

At a Step S308, a parameter set associated with the present measurement temperature is generated through the parameter extraction based on the read intermediate data 23, the device structure data 22 and the change ratio mentioned above. If the reference-temperature parameter sets tend to increase in accordance with the measurement temperature, the parameter set associated with the present measurement temperature is generated such that the monotonic increase tendency is maintained. On the other hand, if the reference-temperature parameter sets tend to decrease in accordance with the measurement temperature, the parameter set associated with the present measurement temperature is generated such that the monotonic decrease tendency is maintained.

At a Step S309, it is judged whether or not the parameter sets are generated for all the measurement temperatures. If there remains a measurement temperature for which the corresponding parameter set is not generated yet, the process returns back to the Step S305 and another measurement temperature is selected. If the parameter sets 24 are generated for all the measurement temperatures, the parameter extraction is finished. In this manner, according to the present embodiment, the plurality of parameter sets 24-1 to 24-n are generated with respect to the plurality of different temperatures, respectively. Here, the plurality of parameter sets 24-1 to 24-n are so generated as to increase or decrease monotonically in accordance with the measurement temperature.

It should be noted that the procedure of generating the parameter sets is not limited to that shown in FIG. 10. For example, the procedure may be once stopped after the reference-temperature parameter sets are generated at the Step S304. In this case, the generated reference-temperature parameter sets are once stored in the storage unit 11 at the Step S304, and then the processes following the Step S305 are carried out after the reference-temperature parameter sets are read from the storage unit 11.

In the present embodiment, the parameter set 24 generated by the foregoing operation can be a device model parameter whose temperature dependency is not supported by the transistor model (BSIM). For example, the device model parameter relates to the GIDL current.

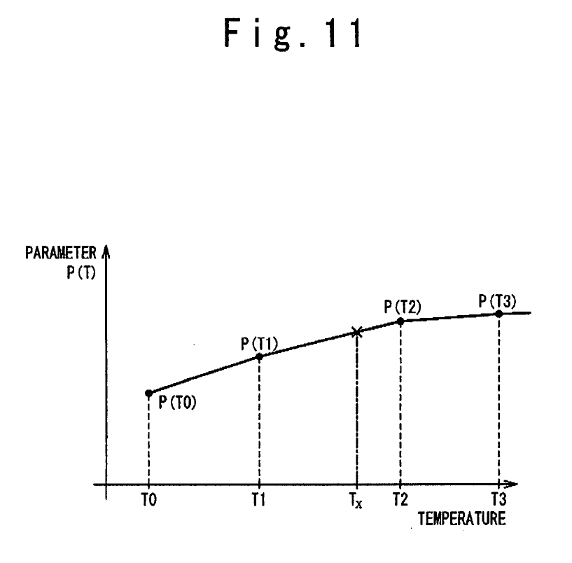

FIG. 11 is a graph for visually explaining the parameter extraction operation according to the present embodiment. In FIG. 11, a parameter P(T) is the device model parameter whose temperature dependency is not supported by the transistor model. Parameters P(T0), P(T1), P(T2) and P(T3) are associated with the measurement temperatures T0, T1, T2 and T3, respectively. Those temperatures have the following relationship; T0<T1<T2<T3. Let us consider a case where the temperature T0 is the above-mentioned first reference-temperature and the temperature T1 is the above-mentioned second reference-temperature. In this case, the parameter P(T0) corresponds to the first reference-temperature parameter set and the parameter P(T1) corresponds to the second reference-temperature parameter set.

In the parameter extraction, the parameters P(T0) and P(T1) associated with the reference-temperature T0 and T1 are first generated. After that, the parameters P(T2) and P(T3) are so generated as to increase or decrease monotonically in accordance with the measurement temperature. If the parameter P(T1) is larger than the parameter P(T0), the other parameters P(T) are so generated as to increase monotonically. On the other hand, if the parameter P(T1) is smaller than the parameter P(T0), the other parameters P(T) are so generated as to decrease monotonically. In the case of FIG. 11, the parameters P(T) increase monotonically in accordance with the temperature T. The generated parameters P(T1) to P(T3) associated with the different temperatures T1 to T3 are stored in the data storage unit 11.

It should be noted that there may be a case where a certain parameter P(T) deviates from the tendency of the monotonic increase or decrease as a result of the parameter extraction. For example, the parameter P(T2) may become smaller than the parameter P(T1) in FIG. 11 and thus the change from the parameter P(T1) to the parameter P(T2) may become reduction. In this case, an error is output to stop the process in the present embodiment. Alternatively, the parameter P(T2) may be treated as a singular point and ignored without stopping the process. That is to say, in the case where the monotonic change is not obtained, the process of outputting an error or setting the parameter P(T2) as a singular point is carried out at the above-mentioned Step S308 in FIG. 10.

Next, the circuit simulation according to the present embodiment will be described below. For example, a temperature Tx shown in FIG. 11 is specified as a simulation temperature used in the circuit simulation. As shown in FIG. 11, the temperature Tx is higher than the temperature T1 and lower than the temperature T2 (T1<Tx<T2). In this case, the parameters P(T1) and P(T2) are used as an input to the circuit simulation. Then, the parameter P(Tx) corresponding to the specified temperature Tx is calculated and generated by interpolating between the parameters P(T1) and P(T2). The generated parameter P(Tx) is applied to the transistor model, instead of the existing parameter whose temperature dependency is not supported by the transistor model. In other words, the existing parameter of the transistor model is replaced by the generated parameter P(Tx). After that, the circuit simulation is executed by using the transistor model and the generated parameter P(Tx). Since the parameter P(Tx) is obtained in consideration of the temperature dependence, the electrical characteristics of the semiconductor device can be estimated with a higher degree of accuracy, even if the temperature dependence of the parameter P is not supported by the transistor model.

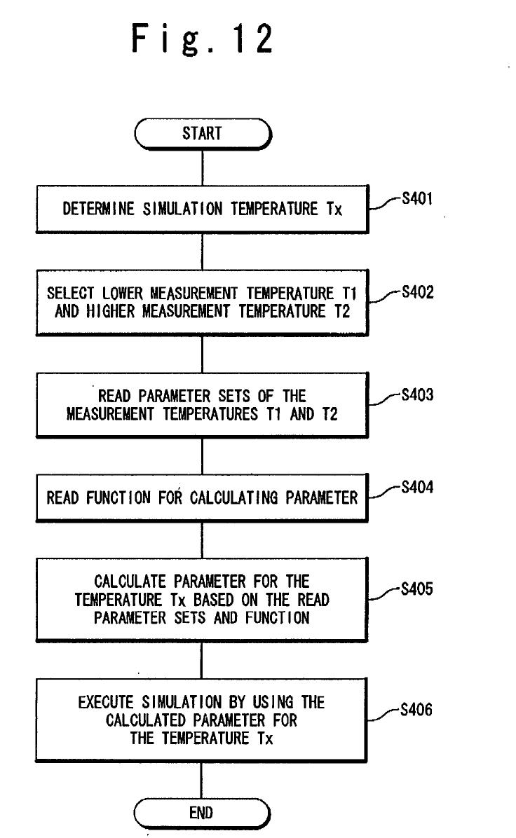

FIG. 12 is a flowchart showing the operation of the circuit simulation according to the present embodiment. At a Step S401, the simulation temperature Tx is determined. At a Step S402, a measurement temperature T1 lower than the temperature Tx and a measurement temperature T2 higher than the temperature Tx are selected (see FIG. 11). At a Step S403, the parameter interpolation program 32 reads a parameter set 24 corresponding to the selected measurement temperature T1 and a parameter set 24 corresponding to the selected measurement temperature T2 from the data storage unit 11. At a Step S404, the parameter interpolation program 32 reads a function used for calculating the device model parameter corresponding to the specified temperature Tx. The function may be incorporated in the parameter interpolation program 32. The function is a function of the temperatures T1, T2 and the device model parameters in the parameter sets 24 associated with the temperatures T1, T2.

For example, let us consider a case of a parameter “AGIDL” of the BSIM4. The parameter “AGIDL” expresses the GIDL current and its temperature dependence is not supported by the BSIM4. According to the present embodiment, a plurality of parameters, AGIDL(T0) to AGIDL(Tn) are generated by the parameter extraction with respect to a plurality of measurement temperatures T0 to Tn, respectively. The function used for calculating a parameter AGIDL(Tx) corresponding to the specified temperature Tx can be given as follows.

AGIDL(Tx)=[(AGIDL(Tj)−AGIDL(Ti)]/(Tj−Ti))* (Tx−Ti)+AGIDL(Ti)

In the above function, the temperatures Ti and Tj are included in the plurality of measurement temperatures T0 to Tn and have a relationship, Ti<Tx<Tj. This function expresses the interpolation.

At a Step S405, the parameter interpolation program 32 calculates the parameter AGIDL(Tx) for the specified temperature Tx by using the above function. .In the case of the example shown in FIG. 11, the parameter AGIDL(Ti) is a parameter AGIDL(T1) associated with the measurement temperature T1 and the parameter AGIDL(Tj) is a parameter AGIDL(T2) associated with the measurement temperature T2. In this manner, the parameter AGIDL(Tx) is calculated and generated based on the above-mentioned function and the parameter sets 24 read in the Step 5403. In other words, the parameter AGIDL(Tx) corresponding to the specified temperature Tx is generated by interpolating between the parameters AGIDL(T1) and AGIDL(T2).

After the device model parameter at the specified temperature Tx is determined, the simulation program 34 executes the circuit simulation by applying the generated device model parameter to the semiconductor device model (Step S406).

It should be noted that the present embodiment is not limited to the above-described case of the parameter AGIDL of the BSIM4. It is also possible to apply the method of the present embodiment to, for example, a parameter A0, a parameter AGS or the like of the BSIM4. In this case, it is possible by the circuit simulation to estimate the ON-current with a high degree of accuracy.

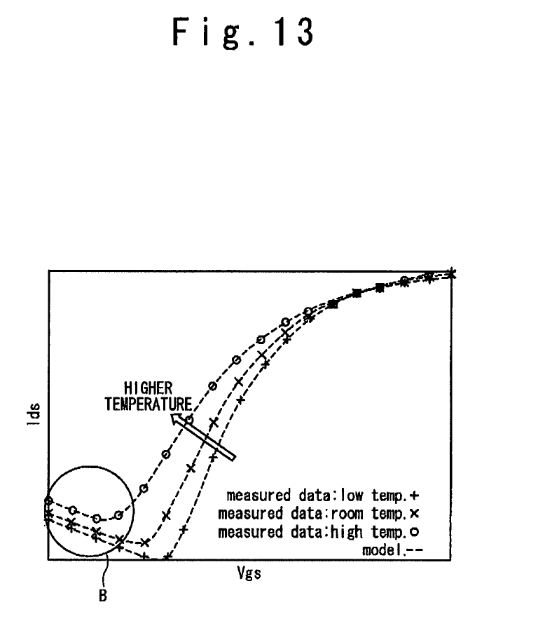

Next, a result of the circuit simulation according to the present embodiment will be explained with reference to FIG. 13. FIG. 13 shows an example of a display image of the result of the circuit simulation. Shown in FIG. 13 is a relation between the Ids−Vgs (drain current−gate voltage) characteristics indicated by the device characteristics measurement data and a result of the circuit simulation according to the present embodiment. A region “B” in FIG. 13 represents the GIDL current. As shown in FIG. 13, the GIDL current is estimated by the circuit simulation with a high precision. As is obvious from a comparison between FIG. 4 and FIG. 13, the precision of the circuit simulation is higher than that of the conventional technique.

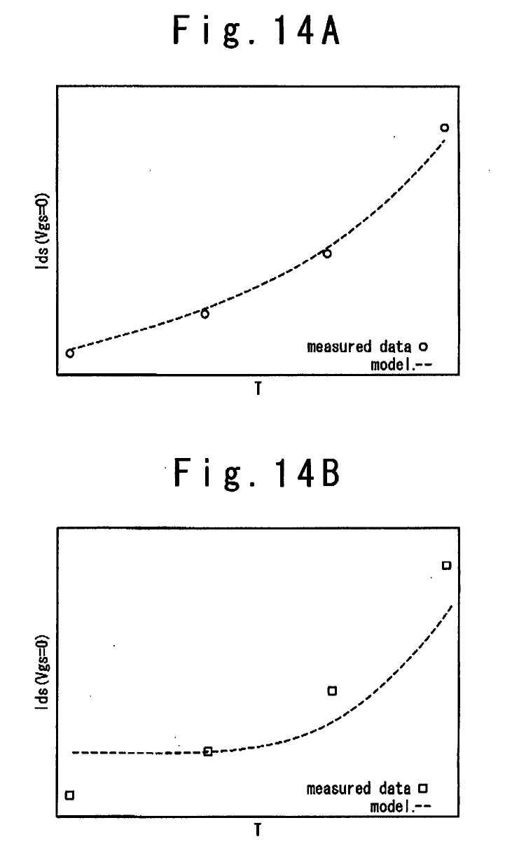

FIGS. 14A and 14B are graphs showing Ids−T (drain current−temperature) characteristics at a time when the gate voltage is 0 V, which is obtained by the circuit simulation. FIG. 14A shows a result of the circuit simulation according to the present embodiment, while FIG. 14B shows a result of the circuit simulation according to the conventional technique. As is obvious from a comparison between FIG. 14A and FIG. 14B, the physical phenomenon of the semiconductor device can be estimated with a higher degree of accuracy in the present embodiment than in the conventional technique.

According to the present invention, as described above, it is possible by the circuit simulation to estimate the physical phenomena of the semiconductor device with a higher degree of accuracy. By developing and manufacturing the semiconductor device on the basis of the result of the circuit simulation, yield and reliability of a product are improved. It is thus possible to reduce the cost of developing and manufacturing the semiconductor device.

It is apparent that the present invention is not limited to the above embodiment and may be modified and changed without departing from the scope and spirit of the invention.

What is claimed is:

1. A circuit simulation method for estimating electrical characteristics of a semiconductor device, comprising:
(A) generating a device model parameter of a semiconductor device model used in a circuit simulation; and
(B) executing said circuit simulation by using said semiconductor device model and said generated device model parameter,
wherein said (A) step includes;
(a) generating a plurality of device model parameters with respect to a plurality of different temperatures; and
(b) generating said device model parameter corresponding to a specified temperature by interpolating between said plurality of device model parameters.

2. The circuit simulation method according to claim 1,
wherein temperature dependence of said device model parameter is not supported by said semiconductor device model.

3. The circuit simulation method according to claim 2,
wherein said (a) step includes:
(a1) reading a plurality of device characteristics measurement data indicating electrical characteristics of said semiconductor device and measured under said plurality of different temperatures; and
(a2) generating said plurality of device model parameters so as to fit in with said plurality of device characteristics measurement data.

4. The circuit simulation method according to claim 3,
wherein in said (a2) step, said plurality of device model parameters are so generated as to increase or decrease monotonically in accordance with temperature.

5. The circuit simulation method according to claim 3,
wherein said plurality of different temperatures include a first temperature, a second temperature higher than said first temperature and a third temperature higher than said second temperature,
wherein said plurality of device characteristics measurement data include:
a first measurement data measured under a condition of said first temperature;
a second measurement data measured under a condition of said second temperature; and
a third measurement data measured under a condition of said third temperature,
wherein said plurality of device model parameters include:
a first device model parameter associated with said first temperature;
a second device model parameter associated with said second temperature; and
a third device model parameter associated with said third temperature,
wherein said (a2) step includes:
(a21) generating said first device model parameter so as to fit in with said first measurement data;
(a22) generating said second device model parameter so as to fit in with said second measurement data; and
(a23) generating said third device model parameter so as to be larger than said second device model parameter if said second device model parameter is larger than said first device model parameter, while generating said third device model parameter so as to be smaller than said second device model parameter if said second device model parameter is smaller than said first device model parameter.

6. A computer program product embodied on a computer-readable medium and, when executed, causing a computer to perform a circuit simulation method comprising:
(A) generating a device model parameter of a semiconductor device model used in a circuit simulation; and
(B) executing said circuit simulation by using said semiconductor device model and said generated device model parameter,
wherein said (A) step includes:
(a) generating a plurality of device model parameters with respect to a plurality of different temperatures; and
(b) generating said device model parameter corresponding to a specified temperature by interpolating between said plurality of device model parameters.

7. The computer program product according to claim 6,
wherein temperature dependence of said device model parameter is not supported by said semiconductor device model.

8. The computer program product according to claim 7,
wherein said (a) step includes:
(a1) reading a plurality of device characteristics measurement data indicating electrical characteristics of said semiconductor device and measured under said plurality of different temperatures from a storage device; and
(a2) generating said plurality of device model parameters so as to fit in with said plurality of device characteristics measurement data.

9. The computer program product according to claim 8,
wherein in said (a2) step, said plurality of device model parameters are so generated as to increase or decrease monotonically in accordance with temperature.

10. The computer program product according to claim 8,
wherein said plurality of different temperatures include a first temperature, a second temperature higher than said first temperature and a third temperature higher than said second temperature,
wherein said plurality of device characteristics measurement data include:
a first measurement data measured under a condition of said first temperature;
a second measurement data measured under a condition of said second temperature; and
a third measurement data measured under a condition of said third temperature,
wherein said plurality of device model parameters include:
a first device model parameter associated with said first temperature;
a second device model parameter associated with said second temperature; and
a third device model parameter associated with said third temperature,
wherein said (a2) step includes;
(a21) generating said first device model parameter so as to fit in with said first measurement data;
(a22) generating said second device model parameter so as to fit in with said second measurement data; and
(a23) generating said third device model parameter so as to be larger than said second device model parameter if said second device model parameter is larger than said first device model parameter, while generating said third device model parameter so as to be smaller than said second device model parameter if said second device model parameter is smaller than said first device model parameter.

11. A circuit simulation apparatus for estimating electrical characteristics of a semiconductor device, comprising;
a parameter generation module configured to generate a device model parameter of a semiconductor device model; and
a simulation module configured to execute a circuit simulation by using said semiconductor device model and said generated device model parameter,
wherein said parameter generation module generates a plurality of device model parameters with respect to a plurality of different temperatures, and generates said device model parameter corresponding to a specified temperature by interpolating between said plurality of device model parameters.

12. The circuit simulation apparatus according to claim 11,
wherein temperature dependence of said device model parameter is not supported by said semiconductor device model.

13. The circuit simulation apparatus according to claim 12,
wherein said parameter generation module reads a plurality of device characteristics measurement data indicating electrical characteristics of said semiconductor device and measured under said plurality of different temperatures, and generates said plurality of device model parameters so as to fit in with said plurality of device characteristics measurement data.

14. The circuit simulation apparatus according to claim 13,
wherein said parameter generation module generates said plurality of device model parameters so as to increase or decrease monotonically in accordance with temperature.
